(19) United States
(12) Patent Application Publication
(10) Pub. No.: US 2025/0019589 A1
(43) Pub. Date: Jan. 16, 2025

(54) Non-Linear Optical Chromophores with Michler's Base-Type Donors

(71) Applicant: Lightwave Logic, Inc., Englewood, CO (US)

(72) Inventors: Ginelle A. Ramann, Centennial, CO (US); Barry L. Johnson, Castle Rock, CO (US); Cory Pecinovsky, Lafayette, CO (US)

(73) Assignee: Lightwave Logic, Inc., Englewood, CO (US)

(21) Appl. No.: 18/761,951

(22) Filed: Jul. 2, 2024

Related U.S. Application Data
(60) Provisional application No. 63/525,539, filed on Jul. 7, 2023.

(51) Int. Cl. C09K 11/06

(52) U.S. Cl. CPC C09K 11/06; C09K 2211/1022; C09K 2211/1088

(57) ABSTRACT

The present invention is directed, in general, to nonlinear optical chromophores having a Michler's base-type group. Various embodiments of the present invention include nonlinear optical chromophores with Michler's base-type group having a Michler's base donor group connected to a Π-bridge group. Various embodiments of the present invention include nonlinear optical chromophores with Michler's base-type group having high photostability, which chromophores can reduce the percentage of being deactivated by molecular oxygen under illumination.

### CROSS-REFERENCE TO RELATED APPLICATIONS

This application claims the benefit of U.S. Provisional Application No. 63/525,539 filed on Jul. 7, 2023, the entire contents of which is incorporated herein by reference.

### BACKGROUND

Nonlinear optical (NLO) chromophores provide the electro-optic (EO) activity in poled, electro-optic polymer devices. Electro-optic polymers have been investigated for many years as an alternative to inorganic materials such as lithium niobate in electro-optic devices. Electro-optic devices may include, for example, external modulators for telecom, RF photonics, and optical interconnects and so forth. Polymeric electro-optic materials have demonstrated enormous potential for core application in a broad range of next-generation systems and devices, including phased array radar, satellite and fiber telecommunications, cable television (CATV), optical gyroscopes for application in aerial and missile guidance, electronic counter measure (ECM) systems, backplane interconnects for high-speed computation, ultraquick analog-to-digital conversion, land mine detection, radio frequency photonics, spatial light modulation and all-optical (light-switching-light) signal processing.

Many NLO molecules (chromophores) have been synthesized that exhibit high molecular electro-optic properties. The product of the molecular dipole moment ( ) and hyperpolarizability (0) is often used as a measure of molecular electro-optic performance due to the dipole's involvement in material processing. See Dalton et al., “New Class of High Hyperpolarizability Organic Chromophores and Process for Synthesizing the Same”, WO 00/09613.

Nevertheless, extreme difficulties have been encountered translating microscopic molecular hyperpolarizabilities (β) into macroscopic material hyperpolarizabilities (x²). Molecular subcomponents (chromophores) must be integrated into NLO materials that exhibit (i) a high degree of macroscopic nonlinearity and (ii) sufficient temporal, thermal, chemical and photochemical stability. Electro-optic activity may be increased in electro-optic polymers by increasing the concentration of nonlinear optical chromophores in a host polymer and by increasing of the electro-optic property of chromophores. However, some techniques for increasing chromophore concentration may decrease poling efficiency and temporal stability. Simultaneous solution of these dual issues is regarded as the final impediment in the broad commercialization of EO polymers in numerous devices and systems.

The production of high material hyperpolarizabilities (x²) is limited by the poor social character of NLO chromophores. Commercially viable materials must incorporate chromophores at large molecular densities with the requisite molecular moment statistically oriented along a single material axis. In order to achieve such an organization, the charge transfer (hyperpolarizability) character of NLO chromophores is commonly exploited through the application of an external electric field during material processing that creates a localized lower-energy condition favoring noncentrosymmetric order. Unfortunately, at even moderate chromophore densities, molecules form multi-molecular dipolarly-bound (centrosymmetric) aggregates that cannot be dismantled via realistic field energies. To overcome this difficulty, integration of anti-social dipolar chromophores into a cooperative material architecture is commonly achieved through the construction of physical barriers (e.g., anti-packing steric groups) that limit proximal intermolecular relations.

Thus, it has often been considered advantageous in the art to produce nonlinear optical chromophore containing materials that exhibit a high glass transition temperature (Tg). Materials with a high glass transition temperature exhibit improved thermal stability and maintain their macroscopic electro-optic properties to a greater degree than materials with lower glass transition temperatures. However, materials with such elevated glass transition temperatures require significantly increased temperatures during poling processes to achieve adequate alignment. The necessity of employing such elevated temperatures is costly, time-consuming and results in what is referred to as poling inefficiency.

### BRIEF SUMMARY

The present invention is directed, in general, to nonlinear optical chromophores having a Michler's base-type group. Various embodiments of the present invention include nonlinear optical chromophores with Michler's base-type group having a Michler's base donor group connected to a H-bridge group. Embodiments of the present invention may include nonlinear optical chromophores with Michler's base-type group having high photostability, which chromophores can reduce the percentage of being deactivated by molecular oxygen under illumination.

Various embodiments of the present invention include nonlinear optical chromophores of the general formula (I):

D-Π-A (I)

wherein D represents an organic electron-donating group; A represents an organic electron-accepting group having an electron affinity greater than the electron affinity of D; and Π represents a Π-bridge between A and D; wherein the Michler's base-type group functions as donor group in the nonlinear optical chromophore.

Nonlinear optical chromophores of the general formula (I) may have a Michler's base-type donor group. In various embodiments of the present invention, nonlinear optical chromophores of the general formula (I) have a Michler's base-type donor group connected to a Π-bridge group. In various embodiments of the present invention, nonlinear optical chromophores of the general formula (I) have high photostability.

Michler's base-type donor groups may be substituted or unsubstituted, including hydro and alkyl substituents, aryl substituents and combinations thereof. In various embodiments, the Michler's base-type donor groups may be symmetrical substituted or unsymmetrical substituted.

Other aspects, features and advantages will be apparent from the following disclosure, including the detailed description, preferred embodiments, and the appended claims.

### BRIEF DESCRIPTION OF SEVERAL VIEWS OF THE DRAWINGS

The foregoing summary, as well as the following detailed description of preferred embodiments of the invention, will be better understood when read in conjunction with the appended drawings. For purposes of illustrating the invention, there are shown in the drawings embodiments which are presently preferred. It should be understood, however, that the invention is not limited to the precise arrangements and instrumentalities shown.

In the drawings:

Spectrograph 100 of FIG. 1 illustrates the differential scanning calorimetry (DSC) of an example Michler's base donor chromophore Pk4.2T of general formula (I), where the three curves 101a-101c show the heat flow-temperature curve over the DSC, whereas the midpoint temperature 102 shows the glass transition temperature (T_{g}) of the example Michler's base donor chromophore Pk4.2T of general formula (I).

FIG. 2 illustrates various examples of Michler's base-type donor groups in accordance with embodiments of the present invention, where 202a-202j show the skeletal formulas of various examples of Michler's base-type donor groups. 202a shows the skeletal formula of the Michler's base-type donor group in chromophore Pk4.2P. 202b shows the skeletal formula of the Michler's base-type donor group in chromophore Pk4.2R. 202c shows the skeletal formula of the Michler's base-type donor group in chromophore Pk4.2S. 202d shows the skeletal formula of the Michler's base-type donor group in chromophore Pk4.2T. 202e shows the skeletal formula of the Michler's base-type donor group in chromophore Pk4.2U. 202f shows the skeletal formula of the Michler's base-type donor group in chromophore Pk4.2V. 202g shows the skeletal formula of the Michler's base-type donor group in chromophore Pk4.2X. 202h shows the skeletal formula of the Michler's base-type donor group in chromophore Pk4.2Z. 202i shows the skeletal formula of the Michler's base-type donor group in chromophore Pk4.3X. 202j shows the skeletal formula of the Michler's base-type donor group in chromophore Pk4.4I.

FIG. 3 illustrates various examples of chromophores with Michler's base-type donor groups in accordance with embodiments of the present invention, where 302a-302j show the skeletal formulas of various examples of chromophores with Michler's base-type donor groups. 302a shows the skeletal formula of chromophore Pk4.2P. 302b shows the skeletal formula of chromophore Pk4.2R. 302c shows the skeletal formula of chromophore Pk4.2S. 302d shows the skeletal formula of chromophore Pk4.2T. 302e shows the skeletal formula of chromophore Pk4.2U. 302f shows the skeletal formula of chromophore Pk4.2V. 302g shows the skeletal formula of chromophore Pk4.2X. 302h shows the skeletal formula of chromophore Pk4.2Z. 302i shows the skeletal formula of chromophore Pk4.3X. 302j shows the skeletal formula of chromophore Pk4.4I.

### DETAILED DESCRIPTION

As used herein, the singular terms “a” and “the” are synonymous and used interchangeably with “one or more” and “at least one,” unless the language and/or context clearly indicates otherwise. Accordingly, for example, reference to “a polymer” or “the polymer” herein or in the appended claims can refer to a single polymer or more than one polymer. As a further example, reference to “a solvent” or “the solvent” herein or in the appended claims can refer to a single solvent or a mixture of more than one solvent. Additionally, all numerical values, unless otherwise specifically noted, are understood to be modified by the word “about.”

As used herein, the term “nonlinear optic chromophore” (NLOC) refers to molecules or portions of a molecule that create a nonlinear optic effect when irradiated with light. The chromophores are any molecular unit whose interaction with light gives rise to the nonlinear optical effect. The desired effect may occur at resonant or nonresonant wavelengths. The activity of a specific chromophore in a nonlinear optic material is stated as its electro-optic coefficient (r₃₃), which is related to dipole moment and hyperpolarizability. The various embodiments of NLO chromophores of the present invention are useful structures for the production of NLO effects.

The first-order hyperpolarizability (0) is one of the most common and useful NLO properties. Higher-order hyperpolarizabilities are useful in other applications such as all-optical (light-switching-light) applications. To determine if a material, such as a compound or polymer, includes a nonlinear optic chromophore with a hyperpolarizability and a sufficient electro-optic coefficient (r₃₃), which is a function of 3, the following test may be performed. First, the material in the form of a thin film is placed in an electric field to align the dipoles. This may be performed by sandwiching a film of the material between electrodes, such as indium tin oxide (ITO) substrates, gold films, or silver films, for example.

To generate a poling electric field, an electric potential is then applied to the electrodes while the material is heated to near its glass transition (T_{g}) temperature. After a suitable period of time, the temperature is gradually lowered while maintaining the poling electric field. Alternatively, the material can be poled by corona poling method, where an electrically charged needle at a suitable distance from the material film provides the poling electric field. In either instance, the dipoles in the material tend to align with the field.

Referring to FIG. 1, the glass transition temperature (T_{g}) of chromophore Pk4.2T is 169.37° C.

The nonlinear optical property of the poled material is then tested as follows. Polarized light, often from a laser, is passed through the poled material, then through a polarizing filter, and to a light intensity detector. If the intensity of light received at the detector changes as the electric potential applied to the electrodes is varied, the material incorporates a nonlinear optic chromophore having an electro-optically variable refractive index. A more detailed discussion of techniques to measure the electro-optic constants of a poled film that incorporates nonlinear optic chromophores may be found in Chia-Chi Teng, Measuring Electro-Optic Constants of a Poled Film, in Nonlinear Optics of Organic Molecules and Polymers, Chp. 7, 447-49 (Hari Singh Nalwa & Seizo Miyata eds., 1997), which is incorporated by reference in its entirety, except that in the event of any inconsistent disclosure or definition from the present application, the disclosure or definition herein shall be deemed to prevail.

The relationship between the change in applied electric potential versus the change in the refractive index of the material may be represented as its EO coefficient r₃₃. This effect is commonly referred to as an electro-optic, or EO, effect. Devices that include materials that change their refractive index in response to changes in an applied electric potential are called electro-optical (EO) devices.

The second-order hyperpolarizability (γ) or third-order susceptibility (x⁽³⁾), are the normal measures of third-order NLO activity. While there are several methods used to measure these properties, degenerate four-wave mixing (DFWM) is very common. See C. W. Thiel, “Four-Wave Mixing and Its Applications,” www.physics.montana.edu.students.thiel.docs/FWMixing.pdf, the entire contents of which are hereby incorporated herein by reference. Referring to Published U.S. Patent Application No. US 2012/0267583A1, the entire contents of which are incorporated herein by reference, a method of evaluating third-order NLO properties of thin films, known in the art as Degenerate Four Wave Mixing (DFWM), can be used. In FIG. 4 of US 2012/0267583A1, Beams 1 and 2 are picosecond, coherent pulses, absorbed by the NLO film deposited on a glass substrate. Beam 3 is a weaker, slightly delayed beam at the same wavelength as Beams 1 and 2. Beam 4 is the resulting product of the wave mixing, diffracted off of the transient holographic grating, produced by interferences of beams 1 and 2 in the NLO material of the film. Beam 3 can be a “control” beam at a telecom wavelength which produces a “signal” beam at a frequency not absorbed by the NLO material.

The photostability is one of the most useful properties of the chromophores. It is important for chromophores to have high photostability because high photostability ensures the chromophores will not degrade under illumination in an air atmosphere. The degradation of chromophores under illumination in the air will happen if double bonds in the chromophores react with molecular oxygen. The molecular oxygen in the air atmosphere may be either triplet oxygen or singlet oxygen. Triplet oxygen is the electronic ground state of molecular oxygen, which means triplet oxygen is the most stable and common allotrope of oxygen and is not reactive toward the double bonds. Light converts triplet oxygen molecules to singlet oxygen molecules, which are very reactive toward double bonds. In summary, singlet oxygen is the reason why the chromophores will degrade under illumination in the air atmosphere. The reaction of singlet oxygen with the double bonds of chromophores will deactivate the chromophores by making the double bonds no longer optically active. Therefore, if a chromophore is resistant to the degradation by singlet oxygen, the chromophore will have high photostability and less resources have to be spent on excluding oxygen from the working device.

Nonlinear optical chromophores suitable for use in accordance with the various embodiments of the invention include those having the general formula (I):

D-Π-A (I)

wherein D represents an organic electron-donating group; A represents an organic electron-accepting group having an electron affinity greater than the electron affinity of D; and Π represents a Π-bridge between A and D. The terms electron-donating group (donor or “D”), Π-bridge (bridging group or “Π”), and electron-accepting group (acceptor or “A”), and general synthetic methods for forming D-Π-A chromophores are known in the art, for example as described in U.S. Pat. Nos. 5,670,091, 5,679,763, 6,090,332, and 6,716,995, and U.S. patent application Ser. No. 17/358,960, filed on Jun. 25, 2021, the entire contents of each of which is incorporated herein by reference.

In nonlinear optical chromophores suitable for use in accordance with various embodiments of the present invention, suitable electron-donating groups can include those according to a general formula (D^{a}).

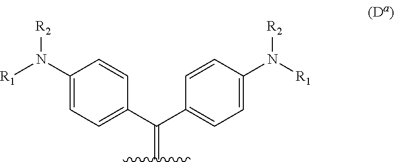

wherein R₁ and R₂ each independently represents a moiety selected from the group consisting of H, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)_{An}where n is 1-10. As used herein,

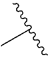

represents a point of bonding to another portion of a larger molecular structure.

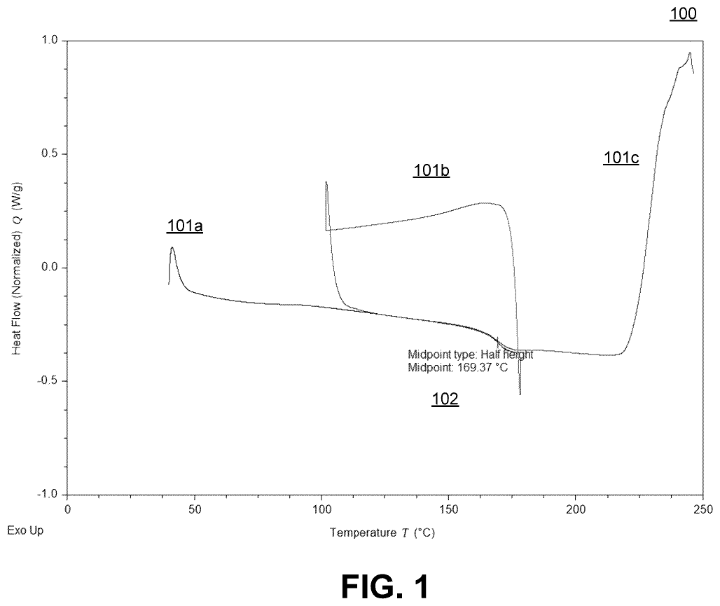

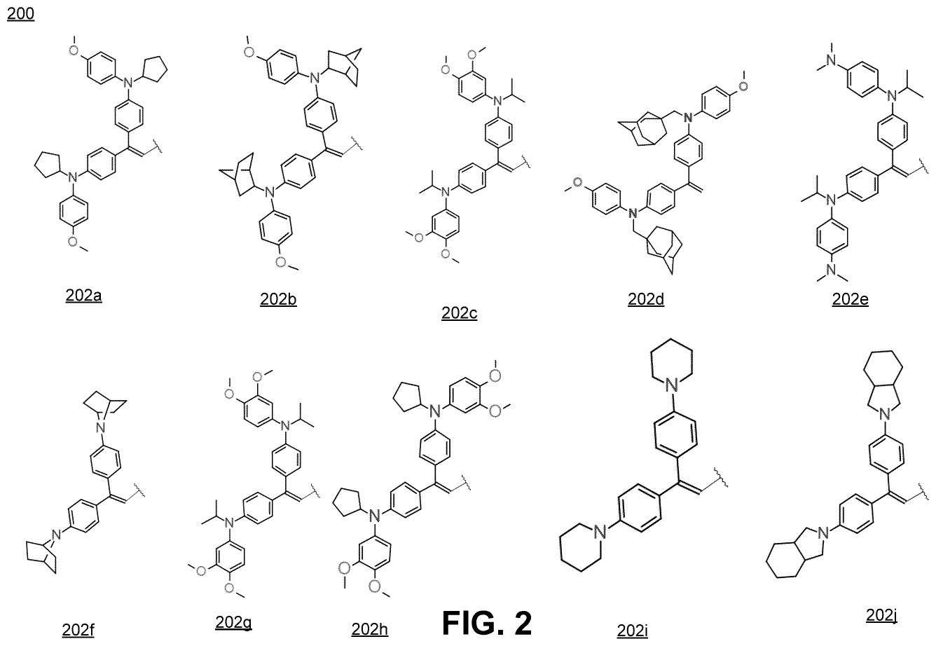

Referring to FIG. 2, various example chromophores in accordance with embodiments of the present invention include the following Michler's base-type donor groups:

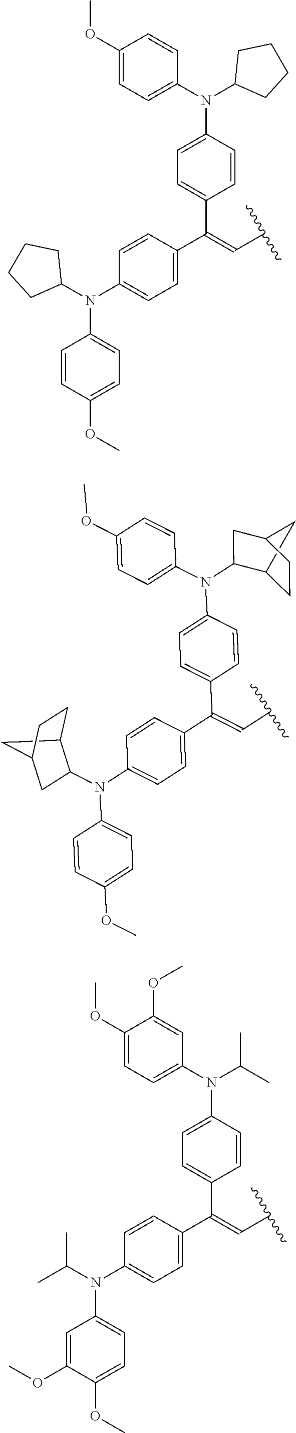 [SMILES: *C=C(c1ccc(N(c2ccc(OC)cc2)C2CCCC2)cc1)c1ccc(N(c2ccc(OC)cc2)C2CCCC2)cc1 ; *C=C(c1ccc(N(c2ccc(OC)cc2)C2CC3CCC2C3)cc1)c1ccc(N(c2ccc(OC)cc2)C2CC3CCC2C3)cc1 ; *C=C(c1ccc(N(c2ccc(OC)c(OC)c2)C(C)C)cc1)c1ccc(N(c2ccc(OC)c(OC)c2)C(C)C)cc1]

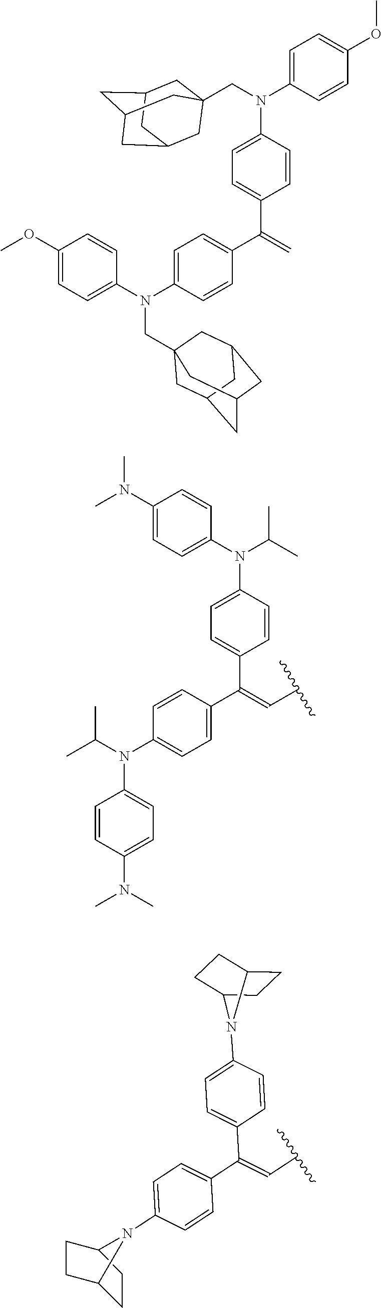

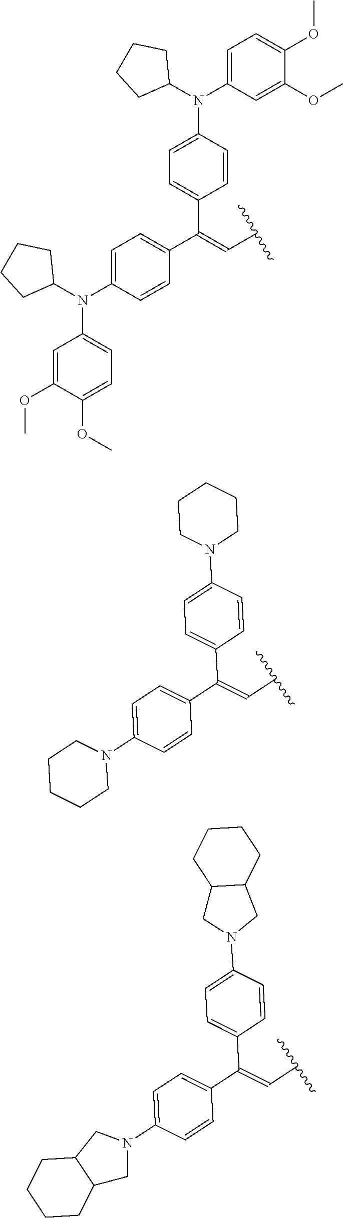 [SMILES: *C=C(c1ccc(N(c2ccc(OC)c(OC)c2)C2CCCC2)cc1)c1ccc(N(c2ccc(OC)c(OC)c2)C2CCCC2)cc1 ; *C=C(c1ccc(N2CCCCC2)cc1)c1ccc(N2CCCCC2)cc1 ; *C=C(c1ccc(N2CC3CCCCC3C2)cc1)c1ccc(N2CC3CCCCC3C2)cc1]

An acceptor is an atom or group of atoms that has a low reduction potential, wherein the atom or group of atoms can accept electrons from a donor through a Π-bridge. The acceptor (A) has a higher electron affinity than does the donor (D), so that, at least in the absence of an external electric field, the chromophore is generally polarized in the ground state, with relatively more electron density on the acceptor (D). Typically, an acceptor group contains at least one electronegative heteroatom that is part of a pi bond (a double or triple bond) such that a resonance structure can be drawn that moves the electron pair of the pi bond to the heteroatom and concomitantly decreases the multiplicity of the pi bond (i.e., a double bond is formally converted to single bond or a triple bond is formally converted to a double bond) so that the heteroatom gains formal negative charge. The heteroatom may be part of a heterocyclic ring. Exemplary acceptor groups include but are not limited to —NO₂, —CN, —CHO, COR, CO₂R, —PO(OR)₃, —SOR, —SO₂R, and —SO₃R where R is alkyl, aryl, or heteroaryl. The total number of heteroatoms and carbons in an acceptor group is about 30, and the acceptor group may be substituted further with alkyl, aryl, and/or heteroaryl.

Suitable electron-accepting groups “A” (also referred to in the literature as electron-withdrawing groups) for nonlinear optical chromophores that can be used in accordance with the various embodiments of the present invention include those described in published U.S. Patent Applications: US 2007/0260062; US 2007/0260063; US 2008/0009620; US 2008/0139812; US 2009/0005561; US 2012/0267583A1 (collectively referred to as “the prior publications”), each of which is incorporated herein by reference in its entirety; and in U.S. Pat. Nos. 6,584,266; 6,393,190; 6,448,416; 6,44,830; 6,514,434; 5,044,725; 4,795,664; 5,247,042; 5,196,509; 4,810,338; 4,936,645; 4,767,169; 5,326,661; 5,187,234; 5,170,461; 5,133,037; 5,106,211; and 5,006,285; each of which is also incorporated herein by reference in its entirety.

In nonlinear optical chromophores suitable for use in accordance with various embodiments of the present invention, suitable electron-accepting groups can include those according to general formula (A^{a}):

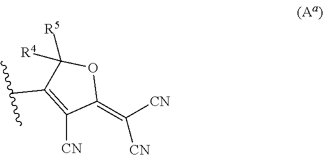

wherein R⁴ and R⁵ each independently represents a moiety selected from the group consisting of H, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10. As used herein,

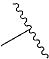

represents a point of bonding to another portion of a larger molecular structure. In various preferred embodiments, one or both of R⁴ and R⁵ represent a halogen-substituted moiety. Halogen-substituted may refer to mono-, di-, tri- and higher degrees of substitution. In various embodiments, one of R⁴ and R⁵ represent a halogen-substituted alkyl moiety and the other represents an aromatic moiety. In various embodiments, one of R² and R³ represent a halogen-substituted aromatic moiety and the other represents an alkyl moiety. In various embodiments, the electron-accepting group can be:

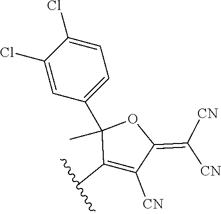 [SMILES: *C1=C(C#N)C(=C(C#N)C#N)OC1(C)c1ccc(Cl)c(Cl)c1]

In various embodiments, the electron-accepting group can be:

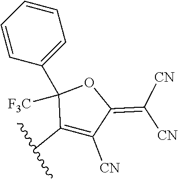 [SMILES: *C1=C(C#N)C(=C(C#N)C#N)OC1(c1ccccc1)C(F)(F)F]

In various embodiments, the electron-accepting group can be:

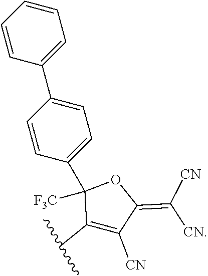 [SMILES: *C1=C(C#N)C(=C(C#N)C#N)OC1(c1ccc(-c2ccccc2)cc1)C(F)(F)F]

A “Π-bridge” includes an atom or group of atoms through which electrons may be delocalized from an electron donor (defined above) to an electron acceptor (defined above) through the orbitals of atoms in the bridge. Such groups are very well known in the art. Typically, the orbitals will be p-orbitals on double (sp²) or triple (sp) bonded carbon atoms such as those found in alkenes, alkynes, neutral or charged aromatic rings, and neutral or charged heteroaromatic ring systems. Additionally, the orbitals may be p-orbitals on atoms such as boron or nitrogen. Additionally, the orbitals may be p, d or f organometallic orbitals or hybrid organometallic orbitals. The atoms of the bridge that contain the orbitals through which the electrons are delocalized are referred to here as the “critical atoms.” The number of critical atoms in a bridge may be a number from 1 to about 30. The critical atoms may be substituted with an organic or inorganic group. The substituent may be selected with a view to improving the solubility of the chromophore in a polymer matrix, to enhance the stability of the chromophore, or for other purposes.

Suitable bridging groups (I) for nonlinear optical chromophores according to general formula (I) can include those described in U.S. Pat. Nos. 6,584,266; 6,393,190; 6,448,416; 6,44,830; 6,514,434; each of which is also incorporated herein by reference in its entirety.

In various embodiments, bridging groups (H) for nonlinear optical chromophores according to general formula (I) can include those of the general formula (II^{a})

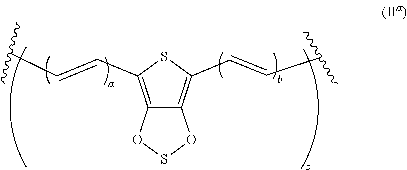

wherein X represents a substituted or unsubstituted, branched or unbranched C₂-C₄ diyl moiety; wherein each a and b independently represents an integer of 0 to 3; and z represents an integer of 1 to 3. In various embodiments wherein a or b in general formula (II^{a}) is 1, that carbon-carbon double bond in the formula can be replaced with a carbon-carbon triple bond. Alternatively, in various embodiments, bridging groups (H) for nonlinear optical chromophores according to general formula (I) can include those of the general formula (II^{b}):

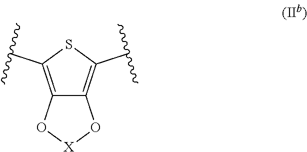

wherein X represents a substituted or unsubstituted, branched or unbranched C₂-C₄ diyl moiety. In various embodiments wherein one or more diamondoid groups is covalently attached to a bridging group according to general formulae I^{a} or II^{b}, the one or more diamondoid groups may be bound, for example, to the sulfur or oxygen atoms of the thiophene group or to one or mor carbon atoms in X through an ether or thioether linkage.

In various embodiments, bridging groups (H) for nonlinear optical chromophores according to general formula (I) can include those of the general formula (II^{c}):

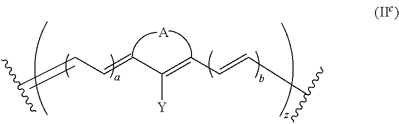

wherein each Y independently represents: a diamondoid-containing group covalently bound to the bridging group through any of the various linkages described herein below including but not limited to ether and thioether linkages; or each Y may represent a hydrogen, an alkyl group, aryl group, sulfur or oxygen linked akyl or aryl group, or a branched or unbranched, optionally heteroatom-containing C₁-C₄ substituent; wherein each a and b independently represents an integer of 0 to 3; z represents an integer of 1 to 3; and wherein each arc A independently represents a substituted or unsubstituted C₂-C₄ alkyl group, which together with the carbon bearing the Y substituent and its two adjacent carbon atoms forms a cyclic group. Substituted or unsubstituted C₂-C₄ alkyl groups which constitute arc A may include 1 to 4 hydrogen substituents each comprising a moiety selected from the group consisting of substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10. In various embodiments, z represents 1. In various embodiments, the electron-donating group or electron-accepting group can include one or more covalently bound diamondoid groups, and Y in general formula II may represent any of the above substituents. In various embodiments, a chromophore may include an electron-donating group including one or more covalently linked diamondoid groups, preferably adamantyl, and the bridging group may include an isophorone group in accordance with general formula II^{c} wherein Y represent an aryl thioether substituent.

In various embodiments, bridging groups (Π) for nonlinear optical chromophores according to general formula (I) can include those of the general formula (II^{d}):

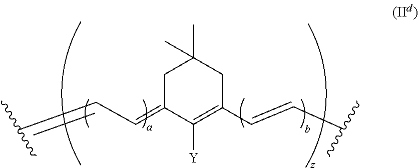

wherein each Y independently represents: a diamondoid-containing group covalently bound to the bridging group through any of the various linkages described herein below including but not limited to ether and thioether linkages; or each Y may represent a hydrogen, an alkyl group, aryl group, sulfur or oxygen linked alkyl or aryl group, an aryl group (optionally bearing a diamondoid group) linked directly by a carbon-carbon bond (e.g., adamantly anisole), a halogen, a halogenated alkyl group, a halogenated aryl group, or a branched or unbranched, optionally heteroatom-containing C₁-C₄ substituent; wherein each a and b independently represents an integer of 0 to 3; and z represents an integer of 1 to 3. In various embodiments, the electron-donating group or electron-accepting group can include one or more covalently bound diamondoid groups, and Y in general formula II^{d} may represent any of the above substituents. In various embodiments, a chromophore may include an electron-donating group including one or more covalently linked diamondoid groups, preferably adamantyl, and the bridging group may include an isophorone group in accordance with general formula II^{d} wherein Y represent an aryl thioether substituent. In various embodiments, each of the geminal methyl groups on the isophorone bridge of the general formula II^{d} can instead independently represent a moiety selected from the group consisting of substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, halogens, halogenated alkyl groups (e.g., —CF₃), halogenated aryls and heteroaryl groups (e.g., pentafluorothiophenol), and (CH₂)ₙ—O—(CH₂)ₙ where n is 1-10.

Various preferred chromophores in accordance with embodiments of the present invention include the Π-bridges of general formula (Π¹):

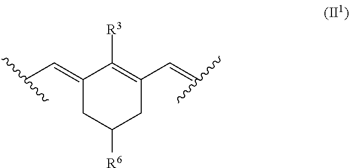

wherein R³ and R⁶ each independently represents a moiety selected from the group consisting of H, halogen, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10.

The choice of R³ and R⁶ groups may rest on polarization of the substituent groups. If a specific substituent group can increase the polarization of the chromophore, this specific substituent group may bring better electro-optic character to the chromophore. For example, “—CF₃” moiety may be a good R⁶ group.

Various preferred chromophores in accordance with embodiments of the present invention include the Π-bridges of general formula (Π²):

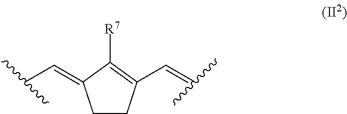

wherein R⁷ represents a moiety selected from the group consisting of H, halogen, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10. The five-membered ring structure in the general formula (Π²) may increase the polarization of the chromophore, which may bring better electro-optic property to the chromophore.

Various example chromophores in accordance with embodiments of the present invention include the following Π-bridges:

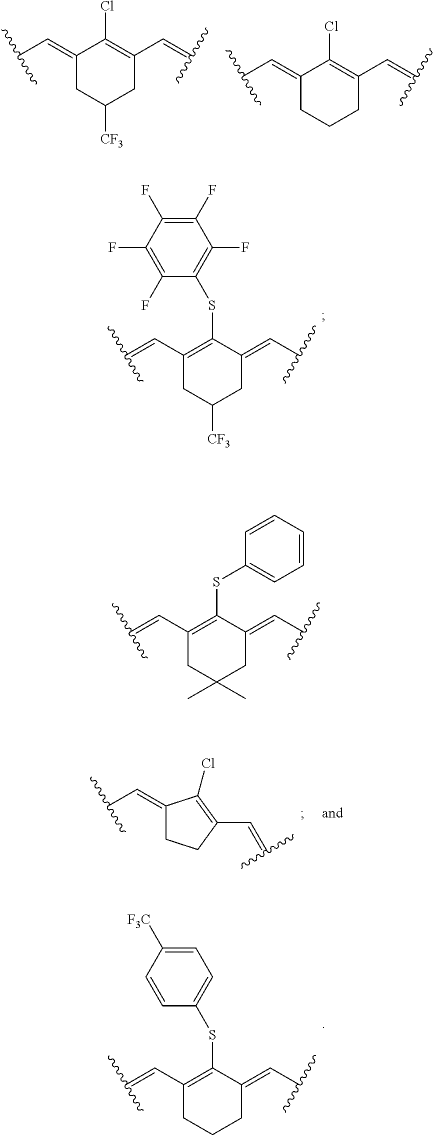 [SMILES: */C=C1\CC(C(F)(F)F)CC(C=*)=C1Cl ; */C=C1\CCCC(C=*)=C1Cl ; */C=C1\CC(C(F)(F)F)CC(C=*)=C1Sc1c(F)c(F)c(F)c(F)c1F ; */C=C1\CC(C)(C)CC(C=*)=C1Sc1ccccc1 ; */C=C1\CCC(C=*)=C1Cl ; */C=C1\CCCC(C=*)=C1Sc1ccc(C(F)(F)F)cc1]

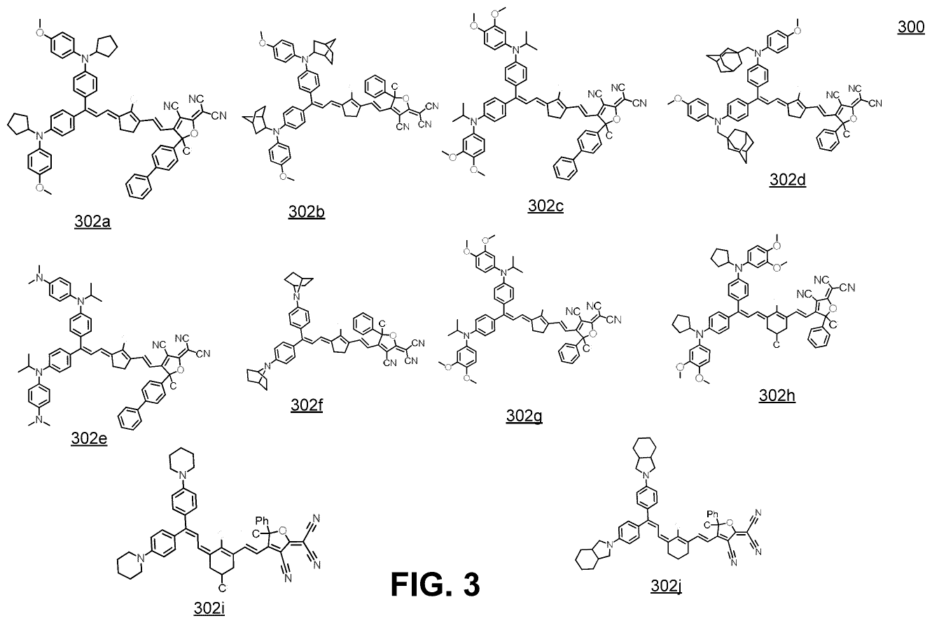

Referring to FIG. 3, examples of chromophores suitable for use in accordance with various embodiments can include chromophore Pk4.2P:

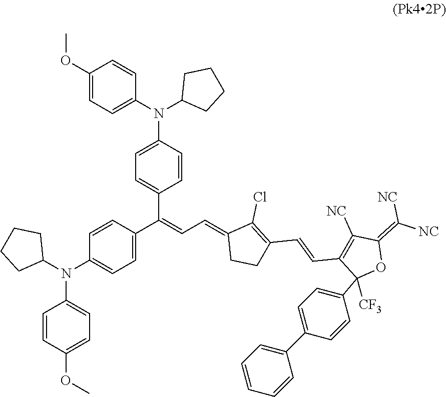

Referring to FIG. 3, examples of chromophores suitable for use in accordance with various embodiments can include chromophore Pk4.2R:

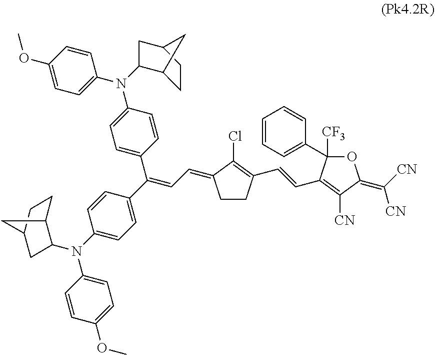 [SMILES: COc1ccc(N(c2ccc(C(=C/C=C3\CCC(/C=C/C4=C(C#N)C(=C(C#N)C#N)OC4(c4ccccc4)C(F)(F)F)=C3Cl)c3ccc(N(c4ccc(OC)cc4)C4CC5CCC4C5)cc3)cc2)C2CC3CCC2C3)cc1]

Referring to FIG. 3, examples of chromophores suitable for use in accordance with various embodiments can include chromophore Pk4.2S:

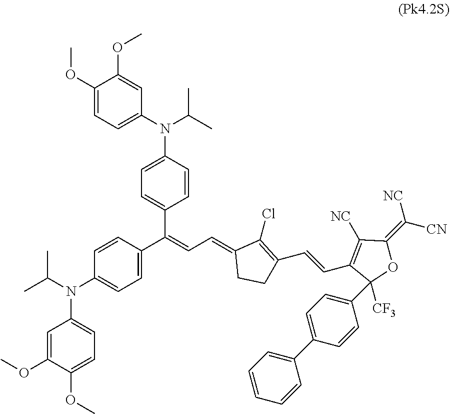 [SMILES: COc1ccc(N(c2ccc(C(=C/C=C3\CCC(/C=C/C4=C(C#N)C(=C(C#N)C#N)OC4(c4ccc(-c5ccccc5)cc4)C(F)(F)F)=C3Cl)c3ccc(N(c4ccc(OC)c(OC)c4)C(C)C)cc3)cc2)C(C)C)cc1OC]

Referring to FIG. 3, examples of chromophores suitable for use in accordance with various embodiments can include chromophore Pk4.2T:

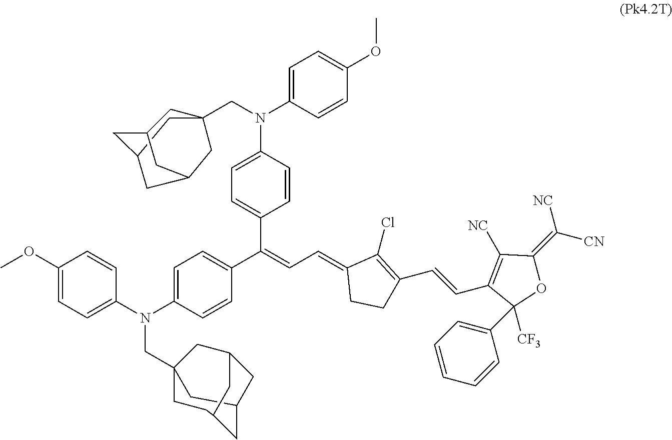 [SMILES: COc1ccc(N(CC23CCC4CC(CC(C4)C2)C3)c2ccc(/C(=C/C=C3\CCC(/C=C/C4=C(C#N)C(=C(C#N)C#N)OC4(c4ccccc4)C(F)(F)F)=C3Cl)c3ccc(N(CC45CC6CC(CC(C6)C4)C5)c4ccc(OC)cc4)cc3)cc2)cc1]

Referring to FIG. 3, examples of chromophores suitable for use in accordance with various embodiments can include chromophore Pk4.2U:

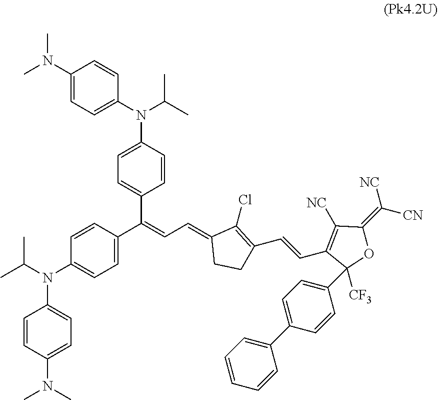 [SMILES: CC(C)N(c1ccc(C(=C/C=C2\CCC(/C=C/C3=C(C#N)C(=C(C#N)C#N)OC3(c3ccc(-c4ccccc4)cc3)C(F)(F)F)=C2Cl)c2ccc(N(c3ccc(N(C)C)cc3)C(C)C)cc2)cc1)c1ccc(N(C)C)cc1]

Referring to FIG. 3, examples of chromophores suitable for use in accordance with various embodiments can include chromophore Pk4.2V:

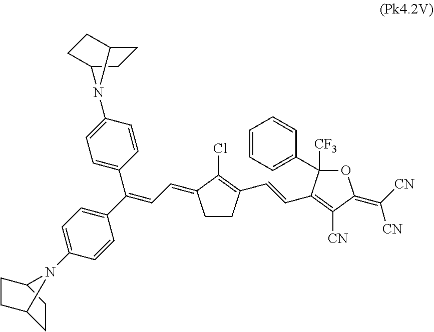 [SMILES: N#CC(C#N)=C1OC(c2ccccc2)(C(F)(F)F)C(/C=C/C2=C(Cl)C(=C/C=C(c3ccc(N4C5CCC4CC5)cc3)c3ccc(N4C5CCC4CC5)cc3)/CC2)=C1C#N]

Referring to FIG. 3, examples of chromophores suitable for use in accordance with various embodiments can include chromophore Pk4.2X:

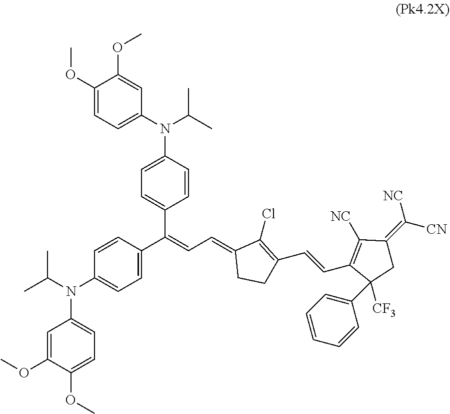 [SMILES: COc1ccc(N(c2ccc(C(=C/C=C3\CCC(/C=C/C4=C(C#N)C(=C(C#N)C#N)CC4(c4ccccc4)C(F)(F)F)=C3Cl)c3ccc(N(c4ccc(OC)c(OC)c4)C(C)C)cc3)cc2)C(C)C)cc1OC]

Referring to FIG. 3, examples of chromophores suitable for use in accordance with various embodiments can include chromophore Pk4.2Z:

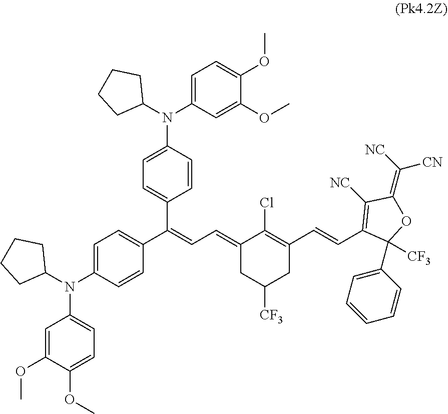 [SMILES: COc1ccc(N(c2ccc(C(=C/C=C3\CC(C(F)(F)F)CC(/C=C/C4=C(C#N)C(=C(C#N)C#N)OC4(c4ccccc4)C(F)(F)F)=C3Cl)c3ccc(N(c4ccc(OC)c(OC)c4)C4CCCC4)cc3)cc2)C2CCCC2)cc1OC]

Referring to FIG. 3, examples of chromophores suitable for use in accordance with various embodiments can include chromophore Pk4.3X:

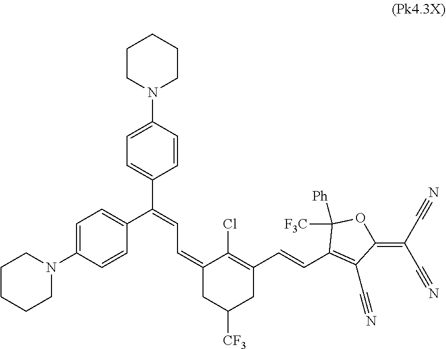 [SMILES: N#CC(C#N)=C1OC(c2ccccc2)(C(F)(F)F)C(/C=C/C2=C(Cl)C(=C\C=C(c3ccc(N4CCCCC4)cc3)c3ccc(N4CCCCC4)cc3)/CC(C(F)(F)F)C2)=C1C#N]

Referring to FIG. 3, examples of chromophores suitable for use in accordance with various embodiments can include chromophore Pk4.41:

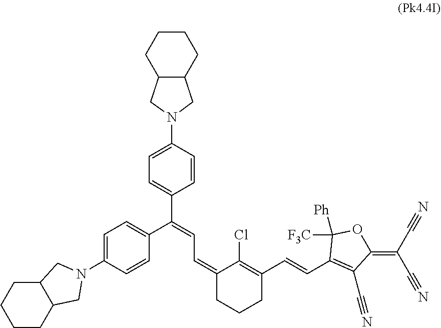 [SMILES: N#CC(C#N)=C1OC(c2ccccc2)(C(F)(F)F)C(/C=C/C2=C(Cl)C(=C\C=C(c3ccc(N4CC5CCCCC5C4)cc3)c3ccc(N4CC5CCCCC5C4)cc3)/CCC2)=C1C#N]

Examples of chromophores suitable for use in accordance with various embodiments can include in addition to all chromophores disclosed in the references incorporated herein by reference, the following:

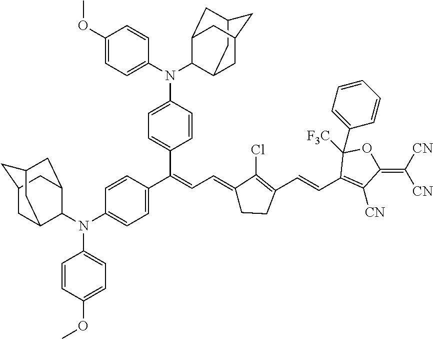 [SMILES: COc1ccc(N(c2ccc(C(=C/C=C3\CCC(/C=C/C4=C(C#N)C(=C(C#N)C#N)OC4(c4ccccc4)C(F)(F)F)=C3Cl)c3ccc(N(c4ccc(OC)cc4)C4C5CC6CC(C5)CC4C6)cc3)cc2)C2C3CC4CC(C3)CC2C4)cc1]

Nonlinear optical chromophores according to the various embodiments of the present invention further include a Michler's base-type donor group connected to H-bridge and function as a donor in the chromophore.

Michler's base-type donor groups suitable for use in the various embodiments of the present invention may be substituted or unsubstituted, including hydro and alkyl substituents, aryl substituents and combinations thereof. Such Michler's base-type groups may be symmetrical substituted or unsymmetrical substituted.

Nonlinear optical chromophores of embodiments herein have a Michler's base-type donor group connected to the Π-bridge, which the chromophores exhibit high photostability. For example, nonlinear optical chromophores having a Michler's base-type donor group can have a 70% photostability or more. The photostability percentage is measured by calculating the amount of chromophore left unchanged and undegraded via UV-Vis absorbance after putting the chromophore under illumination for 20 hours. For example, 75% photostability means 75% of the chromophores are unchanged while only 25% of the chromophores are deactivated by the light and/or singlet oxygen under illumination for 20 hours. Therefore, a higher photostability percentage indicates a high photostability of the chromophores.

Photostability percentage data of various embodiments in nonlinear optical chromophores having a Michler's base-type donor group is summarized as follows:

| Chromophores | Photostability |
|---|---|
| Pk4.2P | 77.7% |
| Pk4.2R | 70% |
| Pk4.2S | 78.2% |
| Pk4.2T | 72.5% |
| Pk4.2U | 92.6% |
| Pk4.2V | 80.3% |
| Pk4.2X | 77.6% |
| Pk4.2Z | 75.9% |
| Pk4.3X | 76% |
| Pk4.4I | 72.6% |

According to certain embodiments, chromophores having a Michler's base-type donor group as described herein may be incorporated in an electro-optic (EO) material. By way of example, an electro-optic (EO) material may comprise one or more nonlinear optic chromophores incorporated within a matrix material. For instance, the EO material may be a neat film of a single-type chromophore having a Michler's base-type donor group. In another example, the EO material may be a film containing a blend of two or more chromophores, in which at least one chromophore has a Michler's base-type donor group. Suitable matrix materials may include polymers, such as, for example: poly(methylmethacrylate)s (PMMA); polyimides; polyamic acid; polystyrenes; poly(urethane)s (PU); and amorphous polycarbonates (APC). In certain examples, the matrix material can comprise a poly(methylmethacrylate), for example having a molecular weight of about 120,000 and a glass transition temperature Tg of about 85-165° C., or an APC having a Tg of about 150-220° C.

According to certain embodiments, EO materials described herein may be implemented in an electro-optic (EO) device. In on example, the EO device is a Mach-Zehnder (MZ) modulator or other waveguide-type device useful for telecommunications applications. Another example EO device is an all-optical device. Such a device may be used, e.g., in optical switching, parametric amplification and other all-optical applications of third-order hyperpolarizability.

What is claimed is:

1. A nonlinear optical chromophore of the general formula (I):
D-Π-A (I)
wherein D represents an organic electron-donating group; A represents an organic electron-accepting group; and Π represents a Π-bridge between A and D, wherein the Π-bridge comprises a carbon chain covalently bound to and separating A and D;
wherein D comprises one Michler's base-type donor group, wherein the Michler's base-type donor group comprises a symmetric Michler's base-type donor, wherein the Michler's base-type donor group represents the symmetric Michler's base-type donor of the general formula (D^{a}): 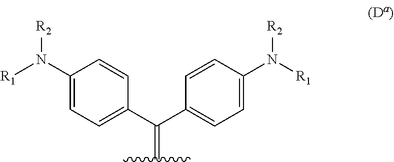
wherein R₁ and R₂ each independently represents a moiety selected from the group consisting of H, unsubstituted C₃-C₁₀ alkyl, substituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10.

2. The nonlinear optical chromophore according to claim 1, wherein A represents an electron-accepting group of the general formula (A^{a}): 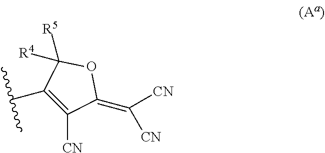
wherein R⁴ and R⁵ each independently represents a moiety selected from the group consisting of H, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10.

3. The nonlinear optical chromophore according to claim 1, wherein Π represents a Π-bridge of the general formula (Π¹): 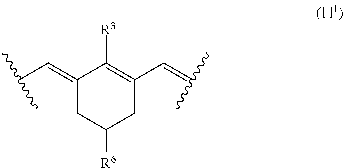
wherein R³ and R⁶ each independently represents a moiety selected from the group consisting of H, halogen, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10.

4. The nonlinear optical chromophore according to claim 3, wherein R⁶ represents a moiety of —CF₃.

5. The nonlinear optical chromophore according to claim 1, wherein Π represents a Π-bridge of the general formula (Π²): 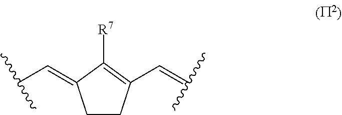
wherein R⁷ represents a moiety selected from the group consisting of H, halogen, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O—(CH₂)ₙ where n is 1-10.

6. The nonlinear optical chromophore according to claim 1, wherein
the nonlinear optical chromophore has the general formula (C′):

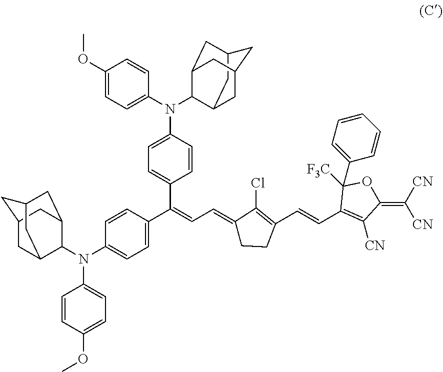

7. The nonlinear optical chromophore according to claim 1, wherein the nonlinear optical chromophore has a photostability greater than or equal to about 70%.

8. The nonlinear optical chromophore according to claim 1, wherein the nonlinear optical chromophore has a photostability greater than or equal to about 75%.

9. The nonlinear optical chromophore according to claim 1, wherein the nonlinear optical chromophore has a photostability greater than or equal to about 80%.

10. The nonlinear optical chromophore according to claim 1, wherein the nonlinear optical chromophore has a photostability greater than or equal to about 90%.
